(19) United States
(12) Patent Application Publication
(10) Pub. No.: US 2022/0315249 A1
(43) Pub. Date: Oct. 6, 2022

(54) AVIATION EQUIPMENT ILLUMINATION PERSONNEL PROTECTION SYSTEM

(71) Applicant: Roy Eliason, South Haven, MN (US)

(72) Inventor: Roy Eliason, South Haven, MN (US)

(21) Appl. No.: 17/142,608

(22) Filed: Jan. 6, 2021

Related U.S. Application Data
(60) Provisional application No. 63/033,581, filed on Jun. 2, 2020.

(51) Int. Cl. B64F 5/40; B64D 45/00

(52) U.S. Cl. CPC B64F 5/40; B64D 45/00; B64D 2045/0085

(57) ABSTRACT

An aviation equipment illumination personnel protection system that includes an aircraft and a light. The aircraft has an engine attached thereto. The engine includes an engine inlet and an engine outlet. The engine is configured such that contact between a person and the engine has the potential to cause significant injury or death to the person. The light is mounted to the aircraft and is capable of illuminating at least a portion of the engine to visually alert the person in proximity to the engine of the presence of the engine and thereby enhance an ability of the person to avoid contact with the engine.

### REFERENCE TO RELATED APPLICATION

This application claims priority to Provisional Applic. No. 63/033,581, filed on Jun. 2, 2020, the contents of which are incorporated herein by reference.

The invention relates generally to systems for protecting people from injuries. More particularly, the invention relates to an aviation equipment illumination personnel protection system.

### BACKGROUND OF THE INVENTION

Preventing injuries to persons who are working near airplanes presents a significant issue. Because airplane engines generate significant noise, it is customary for persons working near the airplanes while the airplane engines are running to wear hearing protection. While such devices are very effective to prevent damage to the person's hearing, these devices reduce the ability of the persons to hear the engines and thereby avoid the engines. In such situations, the person may come sufficiently close to the airplane engine to be contacted by the engine and/or be sucked into the engine, which could result in injury and/or death to the person.

### SUMMARY OF THE INVENTION

An embodiment of the invention is directed to an aviation equipment illumination personnel protection system that includes lights mounted to an airplane to illuminate potentially hazardous parts of the airplane and thereby facilitate persons being aware of and avoiding injury or death caused by the potentially hazardous parts of the airplane.

Another embodiment of the invention is directed to an aviation equipment illumination personnel protection system that includes an aircraft and a light. The aircraft has an engine attached thereto. The engine includes an engine inlet and an engine outlet. The engine is configured such that contact between a person and the engine has the potential to cause significant injury or death to the person. The light is mounted to the aircraft and is capable of illuminating at least a portion of the engine to visually alert the person in proximity to the engine of the presence of the engine and thereby enhance an ability of the person to avoid contact with the engine.

Another embodiment of the invention is directed to a method of protecting personnel using aviation equipment illumination. An aircraft is provided having an engine attached thereto. The engine includes an engine inlet and an engine outlet. The engine is configured such that contact between a person and the engine has the potential to cause significant injury or death to the person; A light is mounted to the aircraft. At least a portion of the engine is illuminated with the light to visually alert the person in proximity to the engine of the presence of the engine and thereby enhance an ability of the person to avoid contact with the engine.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a side view of an airplane that includes an aviation equipment illumination personnel protection system according to an embodiment of the invention.

FIG. 2 is a partially broken away perspective view of an airplane engine that includes the aviation equipment illumination personnel protection system.

FIG. 3 is a front view of an airplane wing with an engine attached thereto that includes the aviation equipment illumination personnel protection system.

### DETAILED DESCRIPTION OF THE INVENTION

An embodiment of the invention is directed to aviation equipment illumination personnel protection as illustrated in the drawings. Through the use of the aviation equipment illumination personnel protection system, it is possible to avoid injury and/or death to persons in proximity to an aircraft 10 caused by contact by a portion of the aircraft 10 such as an engine 22 and/or being sucked into the engine 22. In certain embodiments, the aircraft 10 is an airplane.

As referenced above, even though the engine 22 makes noise when operating, the personnel in proximity to the airplane 10 typically wear hearing protection devices, which reduces the potential of the noise causing the personnel to be aware of the engine 22 being in proximity to the personnel.

The invention utilizes lights 24 mounted to the airplane 10 to illuminate potentially hazardous parts of the airplane 10 that pose a hazard to personnel such as the engine 22 and thereby make the person aware of the hazard such that the person can avoid the hazard.

The lights 24 may be mounted on the surface of the airplane 10. Alternatively, lights 24 may be recessed into a surface of the airplane 10 such that an outer surface of the light 24 is aligned with the outer surface of the airplane 10.

In one configuration, the lights 24 are mounted to the engine 22. In one embodiment, the lights 24 are mounted to the engine 22 proximate an inlet end thereof such as on a leading edge of the engine 22. Alternatively or additionally, the lights 24 may be mounted on an outer surface of the engine 22 proximate the inlet end thereof. It is also possible for the lights 24 to be mounted on an inner surface of the engine 22 proximate the inlet end and/or outlet end thereof.

In certain embodiments, the lights 24 are mounted to the engine 22 in a spaced- apart configuration that extends substantially around the inlet end of the engine 22. In other embodiments, the lights 24 are mounted to the engine 22 only on parts of the engine 22 that are likely to be contacted by personnel such as the lower part of the engine 22.

The lights 24 may also be mounted proximate an outlet end of the engine 22 in situations where the outlet end of the engine 22 presents a risk of injury. For example, gas flows out of the outlet end at a high velocity such that it poses a risk of knocking over a person or otherwise causing injury or death to the person.

FIG. 2 illustrates that the lights 40 may additionally or alternatively be mounted on the outer surface of the engine 22. In certain embodiments, the lights 40 are mounted on the outer surface of the engine 22 proximate a front end thereof.

FIG. 2 also illustrates lights 42, 44 on the interior of the engine 22 to illuminate the blades 46. One set of lights 42 is mounted to the engine 22 forward of the blades 46 and one set of lights 44 is mounted to the engine 22 aft of the blades 46. In addition to reducing the potential of persons contacting the engine 22, the lights 42, 44 may be beneficial to evaluate the condition of the blades 46 for damage such as from birds or debris.

Depending on whether the engine 22 is manufactured with the lights or if the lights are later added to the engine 22, the engine 22 may include at least one aperture 36 that is proximate where the lights are attachable to the engine 22 to receive wiring associated with the lights.

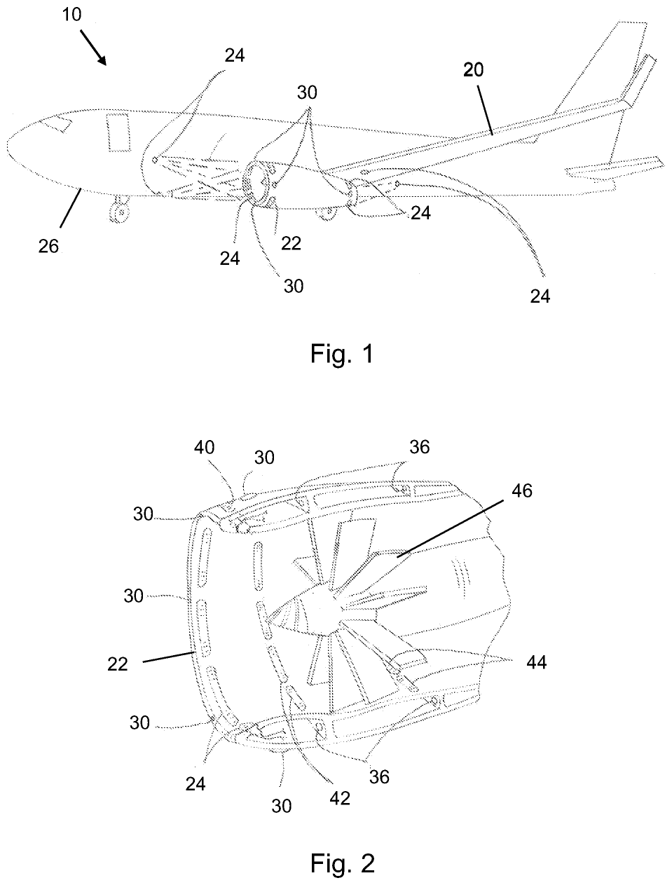

It is also possible for the lights 24 to be mounted to the airplane fuselage 26 sufficiently close to the engine 22 to illuminate potentially hazardous portions of the engine 22 such as illustrated in FIG. 1 where the lights 24 are mounted to the fuselage 26 forward and aft of the engine 22.

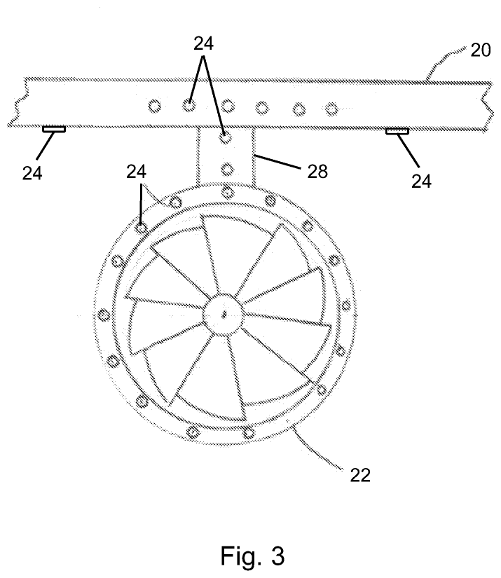

While FIG. 3 illustrates the lights 24 mounted on the front of the engine 22, it is also possible to mount the lights 24 on the wing 20 or a pylon 28 that attaches the engine 22 to the wing 20. In addition to mounting the lights 24 emitting light in a direction that faces in a direction towards a front of the engine 22, it is also possible to orient the lights in other directions such as facing downward. In such situations, the lights 24 may be mounted to the wing 20 inside and/or outside of where the engine 22 is attached to the wing 20.

The lights 24 may be continuously illuminated to provide the warning of the potentially hazardous airplane parts. Alternatively, the lights 24 may only be illuminated when there is a person in proximity to the potentially hazardous parts on the airplane 10. By illuminating the lights 24 when persons are in proximity to the potentially hazardous parts on the airplane 10, the lights 24 may more effectively warn the person of the hazard in proximity thereto as compared to when the lights are continuously illuminated.

Even in situations where the lights 24 are continuously illuminated, the lights 24 may only be illuminated when the potentially hazardous parts of the airplane 10 are in operation such as the engine 22 being turned on.

To facilitate illuminating the lights 24 when the person is in proximity to the potentially hazardous parts on the airplane 10, at least one motion sensor 30 may be mounted to the airplane 10. In certain embodiments, the motion sensor 30 may be incorporated into the light 24. In other embodiments, the motion sensor 30 is separate from the light 24.

The motion sensor(s) is positioned on the airplane 10 facing directions in which the personnel would likely be located. However, the motion sensor 30 does not need to be mounted in proximity to the lights 24. It is also not necessary for the motion sensor 30 to be mounted to the same part of the airplane 10 as the lights 24. A person of skill in the art will appreciate that there are a variety of types of motion sensors 30 may be used in conjunction with the invention.

In one form, the motion sensor 30 causes the lights 24 to turn on in response to sensing the person being in proximity to the potentially hazardous part of the airplane 10. In other embodiments, the motion sensor 30 causes the illumination of the lights 24 to change based upon the distance between the person and the potentially hazardous part of the airplane 10.

In one such configuration, the illumination intensity of the light 24 increases as the person gets closer to the potentially hazardous part of the airplane 10. In another configuration, the illumination color of the light 24 changes as the person gets closer to the potentially hazardous part of the airplane 10. For example, the illumination color may change from green to yellow and then to red as the person gets closer to the potentially hazardous part of the airplane 10 similar to the manner in which a conventional stop light operates.

In yet another configuration, the illumination pattern changes as the person gets closer to the potentially hazard part of the airplane 10. For example, the light 24 may flash at an increasingly faster rate as the person gets closer to the potentially hazardous part of the airplane 10. In still another embodiment, the number of lights 24 that are illuminated may increase as the person gets closer to the potentially hazardous part of the airplane 10.

The lights 24 may also be operably connected to the engine 22 such that the operation of the lights 24 is related to the power level at which the engine 22 is operated. For example, the lights 24 may not illuminate when the engine 22 is operated at a low power level and when the power level at which the engine 22 is operated increases, the illumination intensity, pattern and/or color of the lights 24 may change to reflect the increased danger associated with the engine 22 operating at a higher power level.

In contrast to the lights conventional provided on aircraft that are intended to facilitate navigation of the aircraft 10 such as when moving on the ground, the lights 24, 42 and 44 of this invention are not intended or positioned to facilitate navigation of the aircraft 10. Rather, the lights 24, 42 and 44 illuminate parts of the aircraft such as the engine 22 to thereby avoid injury and/or death to personnel who are proximate the aircraft while the aircraft is on the ground.

It is also possible to include a maintenance light on the aircraft 10 and/or on the engine 22 that is used in conjunction with diagnosis and/or maintenance of the engine 22. The maintenance light may be the same as the lights 24, 42 and 44 or the maintenance light may be different than the lights 24, 42, 44. When the maintenance light is the same as the lights 24, 42 and 44, the aircraft 10 may include a switch to change from operation mode to maintenance mode.

The maintenance light may indicate an operating condition of the engine 22. For example, if all systems of the engine 22 are operating correctly, the maintenance light may illuminate green. The maintenance light may change color, illumination pattern and/or illumination color if one of more aspects of the engine 22 are not operating correctly. Alternatively or additionally, the maintenance light may change illumination color, illumination pattern and/or illumination intensity based upon a rotational speed of the engine 22.

Because of the combination illumination color, illumination pattern and illumination intensity, the concepts discussed herein are suitable for use by colorblind persons as well as for use by persons who are not colorblind.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. An aviation equipment illumination personnel protection system comprising:
an aircraft having an engine attached thereto, wherein the engine comprises an engine inlet and an engine outlet wherein the engine is configured such that contact between a person and the engine has the potential to cause significant injury or death to the person; and
a light mounted to at least one of the aircraft and the engine, wherein the light is capable of illuminating at least a portion of the engine to visually alert the person in proximity to the engine of the presence of the engine and thereby enhance an ability of the person to avoid contact with the engine.

2. The aviation equipment illumination personnel protection system of claim 1, wherein the light is mounted to the aircraft to illuminate at least one of the engine inlet and the engine outlet.

3. The aviation equipment illumination personnel protection system of claim 1, wherein the light is mounted proximate to at least one of the engine inlet and the engine outlet.

4. The aviation equipment illumination personnel protection system of claim 1, wherein the engine comprises an engine inner surface and an engine outer surface and wherein the light is attached to at least one of the engine inner surface and the engine outer surface.

5. The aviation equipment illumination personnel protection system of claim 1, and further comprising at least one of a motion sensor and a proximity sensor that is operably controlling illumination of the light.

6. The aviation equipment illumination personnel protection system of claim 1, wherein the engine comprises an engine inner surface and an engine blade, wherein the engine blade is operably mounted to the engine, wherein the light comprises a first set of lights and a second set of lights, wherein the first set of lights is attached to the engine inner surface between the engine inlet and the engine blade and wherein the second set of lights is attached to the engine inner surface between the engine outlet and the engine blade.

7. The aviation equipment illumination personnel protection system of claim 1, wherein the engine comprises an engine inner surface and an engine blade, wherein the engine blade is operably mounted to the engine, wherein the light comprises a first set of lights and a second set of lights, wherein the first set of lights is attached to the engine inner surface proximate the engine inlet and wherein the second set of lights is attached to the engine inner surface between the first set of lights and the engine blade.

8. The aviation equipment illumination personnel protection system of claim 1, wherein the lights are mounted to a surface of the aircraft or recessed in the surface of the aircraft.

9. The aviation equipment illumination personnel protection system of claim 1, wherein the engine blade is operably mounted in the engine between the engine inlet and the engine outlet.

10. A method of protecting personnel using aviation equipment illumination comprising:
providing an aircraft having an engine attached thereto, wherein the engine comprises an engine inlet and an engine outlet, wherein the engine is configured such that contact between a person and the engine has the potential to cause significant injury or death to the person;
mounting a light to at least one of the aircraft and the engine; and
illuminating at least a portion of the engine with the light to visually alert the person in proximity to the engine of the presence of the engine and thereby enhance an ability of the person to avoid contact with the engine.

11. The method of claim 10, and further comprising changing at least one of an illumination color, an illumination pattern and an illumination intensity as a distance between the light and the person decreases.

12. The method of claim 10, and further comprising changing at least one of an illumination color, an illumination pattern and an illumination intensity based an operational status of the engine.

13. The method of claim 12, wherein the operation status of the aircraft engine is off, low power mode and high power mode.

14. The method of claim 10, wherein the illumination from the light does not appreciably assist a pilot in navigating the aircraft.

15. The method of claim 10, wherein the mounting of the light enables the light to illuminate at least one of the engine inlet and the engine outlet and wherein the mounting of the light is proximate at least one of the engine inlet and the engine outlet.

16. The method of claim 10, wherein the engine comprises an engine inner surface and an engine outer surface and wherein the mounting of the light is proximate at least one of the engine inner surface and the engine outer surface.

17. The method of claim 10, and further comprising:
using at least one of a motion sensor and a proximity sensor to sense a presence of the person near the engine; and
operably controlling illumination of the light based upon the sensed presence of the person.

18. The method of claim 10, wherein the engine comprises an engine inner surface and an engine blade, wherein the engine blade is operably mounted to the engine, wherein the light comprises a first set of lights and a second set of lights and wherein the method further comprises:
attaching the first set of lights to the engine inner surface between the engine inlet and the engine blade; attaching the second set of lights to the engine inner surface between the engine outlet and the engine blade;
illuminating the engine inlet with the first set of lights; and
illuminating the engine outlet with the second set of lights.

19. The method of claim 10, wherein the engine comprises an engine inner surface and an engine blade, wherein the engine blade is operably mounted to the engine, wherein the light comprises a first set of lights and a second set of lights and wherein the method further comprises:
attaching the first set of lights to the engine inner surface proximate the engine inlet;
attaching the second set of lights to the engine inner surface between the first set of lights and the engine blade;
illuminating the first set of lights when the person is less than a first distance from the engine; and
illuminating the second set of lights when person is less than a second distance from the engine, wherein the second distance is smaller than the first distance.

20. The method of claim 19, wherein at least one of an illumination color of the first set of lights is different than an illumination color of the second set of lights, an illumination pattern of the first set of lights is different than an illumination pattern of the second set of lights, and an illumination intensity of the first set of lights is different than an illumination intensity of the second set of lights.

21. A method of evaluating maintenance issues of an aircraft engine, wherein the method comprises:
providing an aircraft having an engine attached thereto, wherein the engine comprises an engine inlet and an engine outlet;
mounting a maintenance light to at least one of the aircraft and the engine such that the maintenance light is visible from proximate the engine; and
illuminating the maintenance light to indicate an operational condition of the engine such that the illumination from the maintenance light may be viewed by a person who is proximate the engine.

22. The method of claim 21, and further comprising changing at least one of an illumination color, illumination pattern and illumination color of the maintenance light in response to a change in the operational condition of the engine.

23. The method of claim 21, and further comprising:
mounting a light to at least one of the aircraft and the engine; and
illuminating at least a portion of the engine with the light to visually alert the person in proximity to the engine of the presence of the engine and thereby enhance an ability of the person to avoid contact with the engine.
